(19) United States
(12) Patent Application Publication
(10) Pub. No.: US 2015/0169324 A1
(43) Pub. Date: Jun. 18, 2015

(54) METHOD AND SYSTEM FOR SOFTWARE ANALYTICS USING BUSINESS INTELLIGENCE

(71) Applicant: Infosys Limited, Bangalore (IN)

(72) Inventors: Girish Maskeri Rama, Bangalore (IN); Deepthi Karnam, Hyderabad (IN)

(21) Appl. No.: 14/493,693

(22) Filed: Sep. 23, 2014

(30) Foreign Application Priority Data
Dec. 17, 2013 (IN) 5875/CHE/2013

(51) Int. Cl. G06F 9/44; G06Q 10/06

(52) U.S. Cl. CPC G06F 8/77; G06F 8/20; G06Q 10/067

(57) ABSTRACT

This technology relates to a method and system for software analytics using business intelligence. The method includes receiving application parameters from a user for an application. The method also includes receiving, data related to the application based on the received application parameters. The method further includes designing an orthogonal dimension model for the application based on the received application parameters; and modeling the received data into the designed orthogonal dimensional model.

This application claims the benefit of Indian Patent Application No. 5875/CHE/2013 filed Dec. 17, 2013, which is hereby incorporated by reference in its entirety.

### BACKGROUND

The invention generally relates to software analytics, and more particularly, to a method and system for software analytics using business intelligence.

Generally, software analytics is applying analytics on software which lead to actionable changes to a project. While ‘mining software repositories’ (MSR) based bug prediction, bug localization, expertise location etc., come under the purview of software analytics, the scope of software analytics is much broader. There are some of the questions managers and developers have to grapple with routinely during software maintenance—“Why did this release have more bugs? Which files do I have to test more? Which open bugs are difficult to fix?” The answers to these questions impact a number of decisions related to tasks such as quality assurance, task allocation, project planning and so on, and thus has a bearing on the project success. Unfortunately, even though some of these decisions are critical and affects the quality of software, they are largely based on experience and gut feeling.

Researchers have realized this problem and have been investigating tools and techniques to mine the huge data generated by software projects to aid software maintenance. However, the focus of these researches largely target specific problems, such as bug prediction, expertise location, bug triaging, bug localization and so on and not on providing decision support in general. In addition, there exists prior work on helping the developers to prevent bugs such as bug prediction. These techniques analyze the historical information in version control systems and issue tracking systems and predict which module or files could be buggy. A majority of the techniques are based on supervised machine learning and the output of the technique is a Boolean function as to whether a given file (or module) could be buggy or not. Few other techniques are based on various formulas involving features such as code churn, complexity and past bugs and yield a probability value (ranging between 0 and 1) that a given file is buggy. In the current state of the art the prediction is not very reliable. Also, existing techniques do not provide the manager or maintainer any insights as to why a given file or module is buggy and what action could be taken by the maintainer. Also managers generally need to take various decisions during maintenance. Existing bug prediction techniques do not provide any such knowledge or decision support to the managers or maintainers.

Although approaches have been taken to address difficulties mentioned above, there is a need for providing decision support to the managers and make better decisions by drilling down and rolling up and getting better insights from the data. Hence, there is a need of a method and system for software analytics using business intelligence to address the aforementioned issues.

### SUMMARY

An object of the invention is to provide a method and system for software analytics using business intelligence. A variety of techniques can be used for applying business intelligence to software analytics.

Another object of the invention is to use the data related to applications to provide rigorous drill down and roll up operations decision support for the user. This is achieved by the invention by identifying the various data needs of users, extracting the data from application history, and modeling that data into various orthogonal dimensions to enable user to take informed decisions. This allows a user to efficiently manage the task of application development and maintenance.

As described herein, a variety of other features and advantages can be into the technologies as desired.

The foregoing and other features and advantages will become more apparent to one skilled in the art from the following detailed description of disclosed embodiments, which proceeds with reference to the accompanying drawings.

To achieve the objectives mentioned above, a method for software analytics using business intelligence is provided. The method includes receiving application parameters for at least one application from a user. The method also includes receiving data related to application based on the received application parameters. The method further includes designing orthogonal dimension model for the application based on the received application parameters. The method also includes modeling the received data into the designed orthogonal dimensional model.

In another embodiment, a computer system for software analytics using business intelligence is provided. The computer system includes a processor for processing data and carrying out operations of the system. The computer system also includes memory storing computer-executable instructions causing the computer system for receiving application parameters for at least one application from a user; receiving data related to application based on received application parameters, designing orthogonal dimension model for the application based on the received application parameters and modeling the received data into the designed orthogonal dimensional model.

### BRIEF DESCRIPTION OF THE DRAWINGS

The accompanying drawings, which constitute a part of this disclosure, illustrate various embodiments and aspects of present invention and together with the description, explain the principle of the invention.

FIG. 1 is a flowchart representing steps involved in an exemplary method for software analytics using business intelligence described herein.

FIG. 2 is a diagrammatic representation of an exemplary system for software analytics using business intelligence described herein.

FIG. 3 is an exemplary list mentioning possible application parameters and potential questions for application parameters described herein.

FIG. 3 is an exemplary list mentioning possible application parameters and potential questions for application parameters described herein.

FIG. 4 is a flowchart representing steps involved in an exemplary method of designing orthogonal dimensional model described herein.

FIG. 5 is a diagrammatic representation of an exemplary dimensional model for software readability described herein.

FIG. 6 is a diagrammatic representation of an exemplary dimensional model for software readability with two dimensions described herein.

FIG. 7 is a diagrammatic representation of an exemplary dimensional model for software readability with three dimensions described herein.

FIG. 8 is a block diagram of an exemplary computing environment suitable for implementing any of the technologies described herein.

### DETAILED DESCRIPTION

### Example 1

### Exemplary Overview

Embodiments of the present invention include a method for software analytics using business intelligence. The method includes receiving application parameters for at least one application from a user. The method also includes receiving data related to application based on received application parameters. The method further includes designing orthogonal dimension model for the application based on the received application parameters. The method also includes modeling the received data into the designed orthogonal dimensional model.

### Example 2

### Exemplary Method of Software Analytics using Business Intelligence

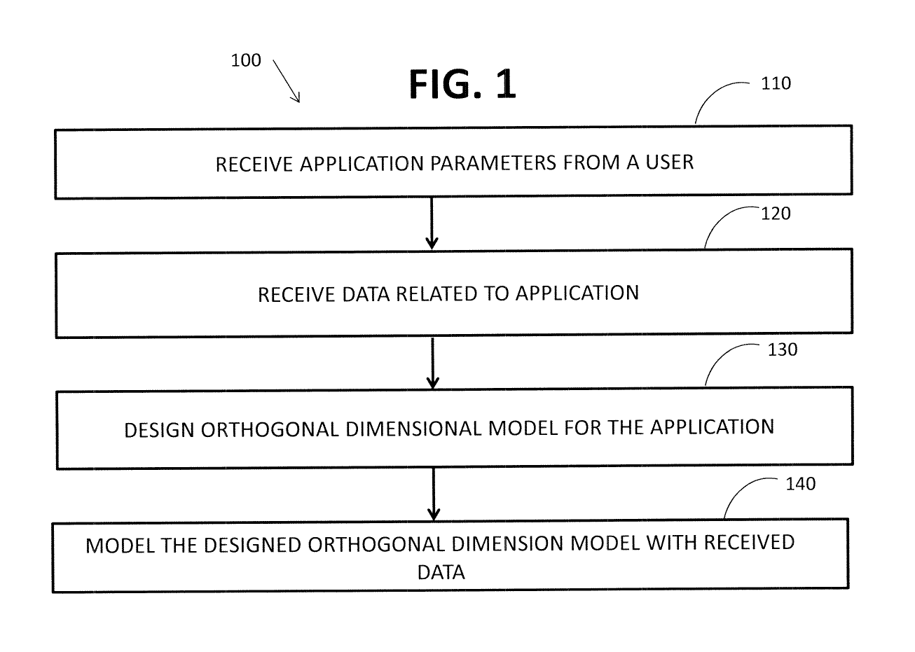

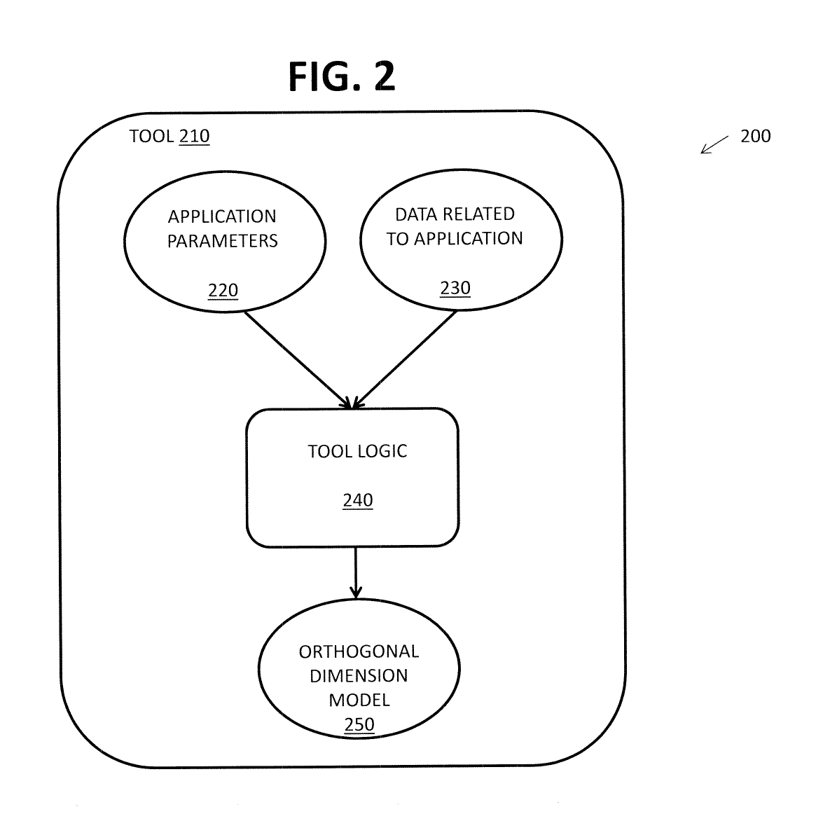

FIG. 1 is a flowchart of an exemplary method 100 of implementing the software analytics using business intelligence described herein and can be implemented for example in a system such a s shown in FIG. 2. The technologies described herein can be generic to the specifics of operating systems or hardware and can be applied in any variety of environments to take advantage of the described features.

At 110, application parameters for at least one application are received from a user. Such application parameters can include identifying at least one application for which decision support is required. Also these application parameters can include identifying potential questions for the identified application.

At 120, data related to the application is received from the operational databases based on the received application parameters. This is a process of extracting data from the databases, transforming them to maintain data consistency and loading into warehouse or data marts for further uses. The data related to application can be any one or a combination of version history, bug history, email archives source code, deployment logs, root cause reports, impact analysis reports and code review reports of the application. The data related to application is not limited and can include various others based on the requirements and the inputted application parameters.

At 130, an orthogonal dimensional model is designed for the application based on the received application parameters. Deigning the orthogonal dimensional model is the most crucial task in building business intelligence. It is defined as a methodology for logically modeling data to maximize analytical query processing and ease of use.

At 140, the data which was received at 120 is modeled into the orthogonal dimensional model which was designed at 130. This orthogonal dimensional model can be but not limited to a multidimensional cube. The cube consists of the aggregated fact information in each level of each dimension. The orthogonal dimensional model is then published for visualization to the user. This visualization can be either reports or dashboards based on the user requirements.

The method 100 and any of the methods described herein can be performed by computer-executable instructions stored in one or more computer-readable media (storage or other tangible media) or stored in one or more compute readable storage devices.

### Example 3

### Exemplary System for Software Analytics using Business Intelligence

FIG. 2 is a block diagram of an exemplary system 200 implementing the software analytics using business intelligence described herein. In the example, one or more computers in a computing environment implement tool 210 that accepts as input application parameters 220 and data related to applications 230. The system 210 includes tool logic 240, which processes application parameters 220 and data 230 to design and model an orthogonal dimensional model 250. The orthogonal dimensional model is then published for visualization to the user by means of display. This visualization can be either reports or dashboards based on the user requirements.

In practice, the systems shown herein, such as system 200 can be more complicated, with additional functionality, more complex inputs, and the like.

In any of the examples herein, the inputs, outputs and orthogonal dimensional model 250 can be stored in one or more computer-readable storage media.

### Example 4

### Exemplary Applications

In any of the examples herein, an application can be any computer software that causes a computer to perform useful tasks beyond the running of computer itself. The application is sometimes called as a software application, program or app. Examples of application include and not limited to accounting software, enterprise software, graphics software, media player etc. The application can be any software capable of being developed or maintained in enterprise.

### Example 5

### Exemplary Applications Parameters and Potential Questions

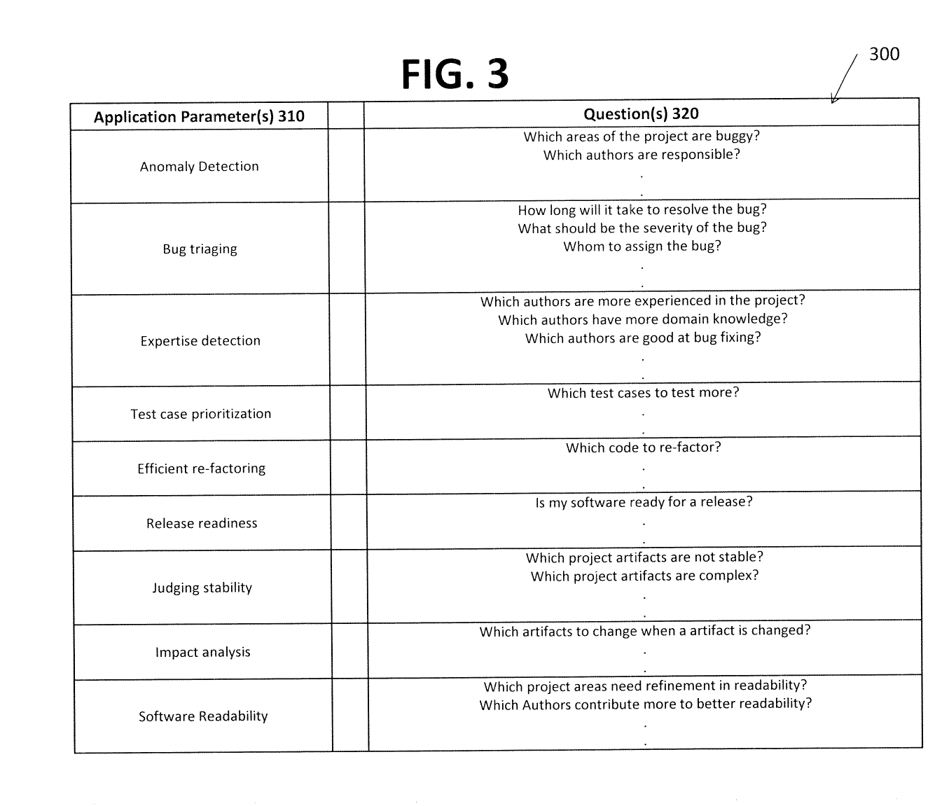

In any of the examples herein, FIG. 3 provides an exemplary list 300 mentioning possible application parameters 310 and potential questions 320 for application parameters 310 that a manager may need for decision making The first and foremost step in software analytics using business intelligence is to identify and understand the requirements of software development and maintenance. Understanding requirements essentially means identifying application parameters and potential questions in software development and maintenance where decision support is required.

For example, Expertise detection is one of the applications parameter in software life cycle which involves certain decisions such as ‘Which developer should be to assigned a task’ etc. To take informed decisions, managers seek answers for certain questions for each of the applications to guide them to take smart decisions.

### Example 6

### Exemplary Method of Designing Orthogonal Dimensional Model

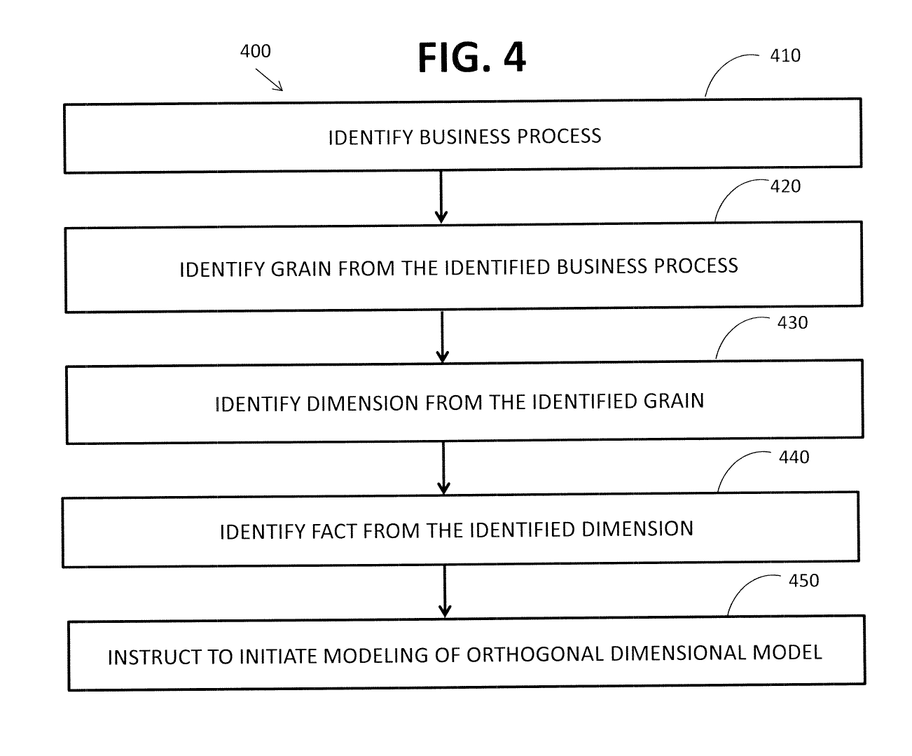

FIG. 4 is a flowchart of an exemplary method 400 of designing orthogonal dimension model. Designing an orthogonal dimensional model is defined as a methodology for logically modeling data to maximize analytical query processing and ease of use. The process of designing an orthogonal dimensional model is basically a multistep process.

At 410, a business process is identified wherein the identification of the business process includes gathering business requirements. Apart from identifying the business requirements, data availability and data quality issues are investigated at this step.

At 420, a grain is identified from the identified business processes. This forms the crux of the dimensional model. A gain is defined as business definition of the measurement event that creates a fact.

At 430, a dimension is identified from the identified grains. The dimension is a group of hierarchies that defines the context for facts.

At 440, at least one fact is identified from the identified dimensions. The fact is a measure when the dimensions are true.

At 450, modeling is initiated once all identification is complete.

For example, for business data with dimensions as item, location and time the grain is ‘items sold in a location for a day’. Similarly if application data is considered with dimensions product, author, time a grain can be number of products changed by an author in a day. Once grain is defined identifying dimensions and facts is fairly simple. ‘For the grain items sold in a location for a day’, dimensions are items, location, time and fact is #items sold, similarly for the grain ‘number of artifacts changed by an author in a day’ the dimensions are artifacts, author, time apart from identifying the dimensions a hierarchy must be defined for each of the dimension. For artifacts the hierarchy can be modules, files, methods etc., for authors the attributes are years of experience, years of experience is project etc., such attributes form a two level attribute hierarchy. Fact is a measure or the value when the dimensions are true. For the above grain, fact is #artifacts.

Following the identified granules a star schema is designed which is the simplest representation of a dimensional model. From the grain definitions, various dimensions and their hierarchies are identified. All dimensions are then classified for application into two groups i.e. application specific dimensions and generic dimensions. Application specific dimensions are dimensions which are specific to an application for e.g. Product, Authors, Churn, and Bugs etc. Whereas generic dimensions are generic in nature for e.g. Location, Time etc. Facts typically form the metrics for the various application parameters and aggregated information such as #authors, #files, #changes, #loc, #bugs etc. for software analytics.

The dimensional models are easily extensible and can accommodate unexpected new data.

### Example 7

### Exemplary Dimensional Model for Software Readability

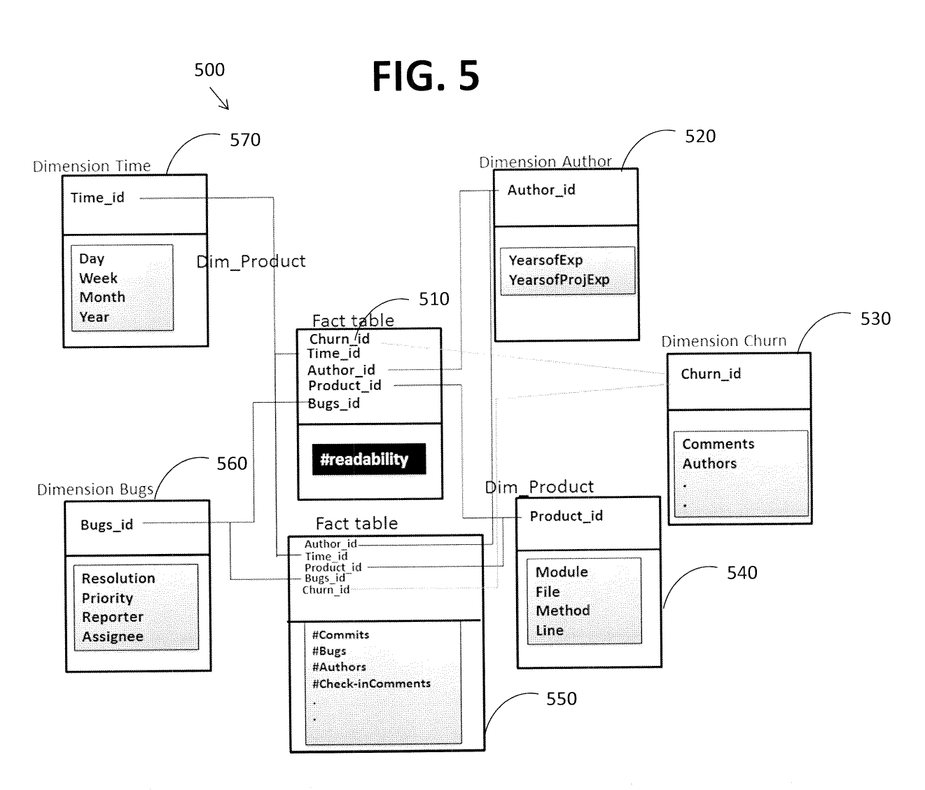

FIG. 5 is the diagrammatic representation of dimensional model for software readability 500 and can be implemented, for example, in a system such as shown in FIG. 2.

In the example, the shown model 500 has two fact tables, the first fact table 510 measures readability using an exemplary metric. The second fact table 550 has the aggregated information such as #Commits, #Bugs, #Authors, #Check-in comments etc. The grain for this dimension model is ‘readability of a snippet for bug fixing by an author in a day’ and the dimensions are Product, Bugs, Author, and Time. Here, the second fact table 520 consists of aggregated data such as #Commits, #Bugs, #Authors etc. The grain for this fact table is ‘Commits made for a snippet by an author for bug fixing in a day’. It uses aggregated information of first fact table in the dimensional model as both are at the same level of granularity. The various dimensions are represented in model 500 are Author 520, Churn 530, Product 540, Bugs 560 and Time 570. The dimension such as product 540 and time 570 has user defined hierarchy whereas Bugs 560, Churn 530, Author 520 dimensions has attribute hierarchy.

### Example 8

### Exemplary Dimensional Model for Software Readability with Two Dimensions

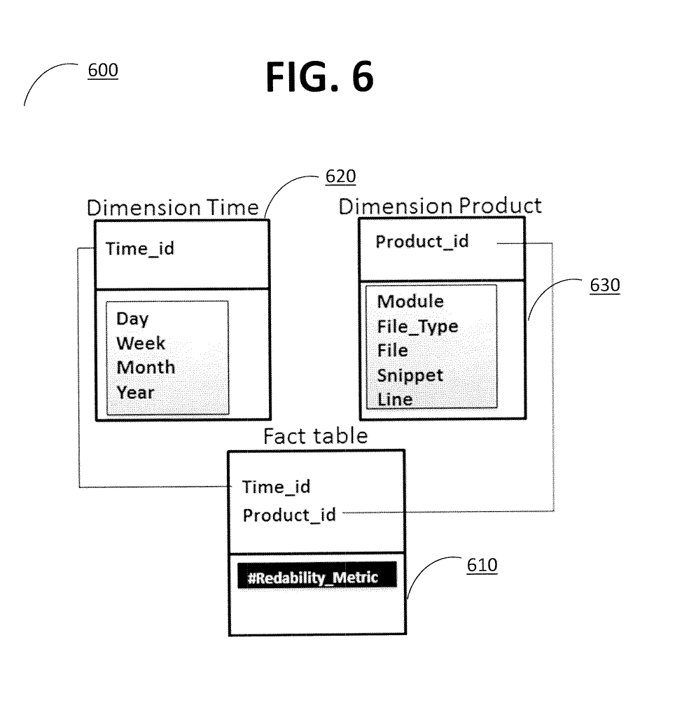

FIG. 6 is the diagrammatic representation of dimensional model for software readability with two dimensions 600 and can be implemented, for example, in a system such as shown in FIG. 2.

In the example, the shown model 600 represents a dimensional model with software readability as a fact table 610 and time 620 and product 630 as dimensions with hierarchy.

### Example 9

### Exemplary Dimensional Model for Software Readability with Three Dimensions

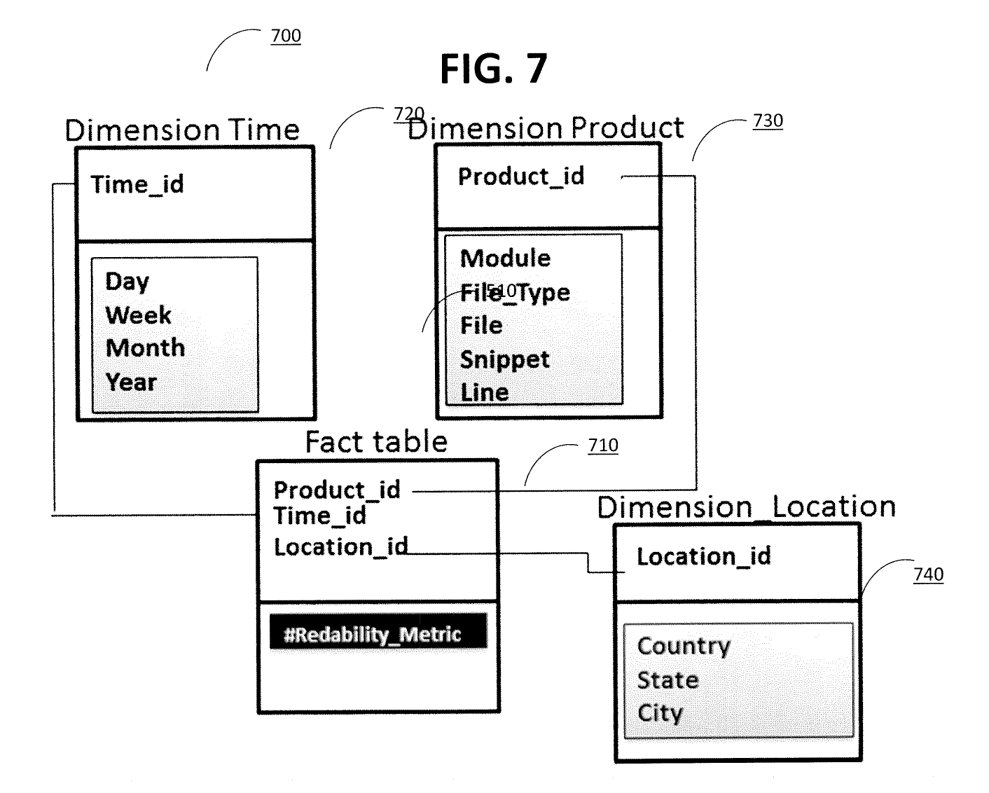

FIG. 7 is the diagrammatic representation of dimensional model for software readability with three dimensions 700 and can be implemented, for example, in a system such as shown in FIG. 2.

In the example, the shown model 700 represents a dimensional model with software readability as a fact table 710. The dimensions in the hierarchy are represented and time 720, product 730 and location 740.

### Example 10

### Exemplary General Process

The general process for software analytics using business intelligence is the use of application information for providing decision support to users. The users can be various developers or managers working involved in the task of application development and or maintenance.

The process can identify various information needs of user required in application development and or maintenance. The process involves receiving of application related information from sources and modeling that information into various orthogonal dimensions by generating an orthogonal dimensional model to enable the developers or managers to take informed decisions.

The system can allow dropdown choices to be able to select, and based on the selection, provide required information in form of orthogonal dimension model.

### Example 11

### Exemplary Computing Environment

The techniques and solutions described herein can be performed by software, hardware, or both of a computing environment, such as one or more computing devices. For example, computing devices include server computers, desktop computers, laptop computers, notebook computers, handheld devices, netbooks, tablet devices, mobile devices, PDAs, and other types of computing devices.

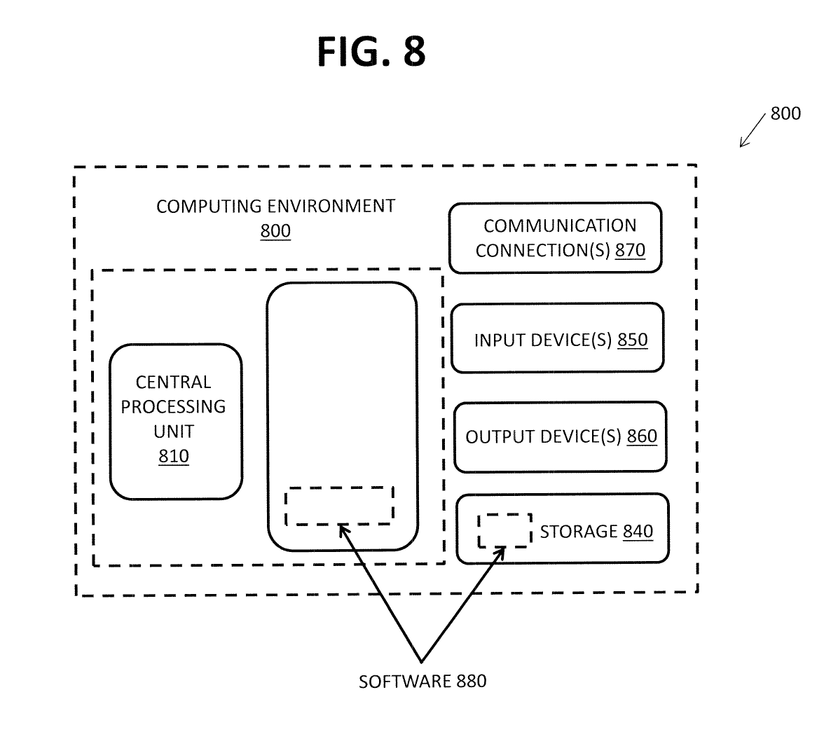

FIG. 8 illustrates an exemplary computing environment 800 in which the described technologies can be implemented. The computing environment 800 is not intended to suggest any limitation as to scope of use or functionality, as the technologies may be implemented in diverse general-purpose or special-purpose computing environments. For example, the disclosed technology may be implemented using a computing device comprising a processing unit, memory, and storage storing computer-executable instructions implementing the enterprise computing platform technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like. The disclosed technology may also be practiced in distributed computing environments where tasks are performed by remote processing devices that are linked through a communications network. In a distributed computing environment, program modules may be located in both local and remote memory storage devices

With reference to FIG. 8, the computing environment 800 can be an analytics computing device including at least one processing unit 810 coupled to memory 820. In FIG. 8, this basic configuration 830 is included within a dashed line. The processing unit 810 executes computer-executable instructions and may be a real or a virtual processor. In a multi-processing system, multiple processing units execute computer-executable instructions to increase processing power. The memory 820 may be volatile memory (e.g., registers, cache, RAM), non-volatile memory (e.g., ROM, EEPROM, flash memory, etc.), or some combination of the two. The memory 820 can store software 880 implementing any of the technologies described herein.

A computing environment may have additional features. For example, the computing environment 800 includes storage 840, one or more input devices 850, one or more output devices 860, and one or more communication connections 870. An interconnection mechanism (not shown) such as a bus, controller, or network interconnects the components of the computing environment 800. Typically, operating system software (not shown) provides an operating environment for other software executing in the computing environment 800, and coordinates activities of the components of the computing environment 800.

The storage 840 may be removable or non-removable, and includes magnetic disks, magnetic tapes or cassettes, CD-ROMs, CD-RWs, DVDs, or any other computer-readable media which can be used to store information and which can be accessed within the computing environment 800. The storage 840 can store software 880 containing instructions for any of the technologies described herein.

The input device(s) 850 may be a touch input device such as a keyboard, mouse, pen, or trackball, a voice input device, a scanning device, or another device that provides input to the computing environment 800. For audio, the input device(s) 850 may be a sound card or similar device that accepts audio input in analog or digital form, or a CD-ROM reader that provides audio samples to the computing environment. The output device(s) 860 may be a display, printer, speaker, CD-writer, or another device that provides output from the computing environment 800.

The communication connection(s) 870 enable communication over a communication mechanism to another computing entity. The communication mechanism conveys information such as computer-executable instructions, audio/video or other information, or other data. By way of example, and not limitation, communication mechanisms include wired or wireless techniques implemented with an electrical, optical, RF, infrared, acoustic, or other carrier.

The techniques herein can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

### Storing in Computer-Readable Media

Any of the storing actions described herein can be implemented by storing in one or more computer-readable media (e.g., computer-readable storage media or other tangible media).

Any of the things described as stored can be stored in one or more computer-readable media (e.g., computer-readable storage media or other tangible media).

### Methods in Computer-Readable Media

Any of the methods described herein can be implemented by computer-executable instructions in (e.g., encoded on) one or more computer-readable media (e.g., computer-readable storage media or other tangible media). Such instructions can cause a computer to perform the method. The technologies described herein can be implemented in a variety of programming languages.

### Methods in Computer-Readable Storage Devices

Any of the methods described herein can be implemented by computer-executable instructions stored in one or more computer-readable storage devices (e.g., memory, magnetic storage, optical storage, or the like). Such instructions can cause a computer to perform the method.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

What is claimed is:

1. A method for software analytics using business intelligence, the method comprising:
receiving, by an analytics computing device, an application parameter from a user for at least one application;
receiving, by the analytics computing device, data related to the application based on the received application parameters;
designing, by the analytics computing device, an orthogonal dimension model for the application based on the received application parameters; and
modeling, by the analytics computing device, the received data into the designed orthogonal dimensional model.

2. The method as claimed in claim 1, wherein the data related to the application comprises a version history, a bug history, email archives, source code, one or more deployment logs, one or more root cause reports, one or more impact analysis reports, or one or more code review reports of the application.

3. The method as claimed in claim 1, wherein the designing further comprises:
identifying a business process, wherein the identifying includes gathering business requirements, a grain from the identified business processes, a dimension from the identified grains, and a fact from the identified dimensions; and
instructing to initiate the modeling of the orthogonal dimensional model.

4. The method as claimed in claim 5, wherein the grain is a business definition of a measurement event that creates the fact, the dimension is a group of hierarchies that defines the context for the fact, and the fact is a measure indicating the dimension is true.

5. The method as claimed in claim 1, wherein the modeling further comprises displaying the orthogonal dimensional model to the user.

6. The method as claimed in claim 1 further comprising providing, by the analytics computing device, an interactive user interface for displaying the information and prompting data entry by the user.

7. An analytics computing device, comprising a processor and a memory coupled to the processor which is configured to be capable of executing programmed instructions comprising and stored in the memory to:
receive an application parameter from a user for at least one application;
receive data related to the application based on the received application parameters;
design an orthogonal dimension model for the application based on the received application parameters; and
model the received data into the designed orthogonal dimensional model.

8. The analytics computing device as claimed in claim 7, wherein the data related to the application comprises a version history, a bug history, email archives, source code, one or more deployment logs, one or more root cause reports, one or more impact analysis reports, or one or more code review reports of the application.

9. The analytics computing device as claimed in claim 7, wherein the processor coupled to the memory is further configured to be capable of executing at least one additional programmed instruction comprising and stored in the memory to:
identify a business process, wherein the identifying includes gathering business requirements, a grain from the identified business processes, a dimension from the identified grains, and a fact from the identified dimensions; and
instruct to initiate the modeling of the orthogonal dimensional model.

10. The analytics computing device as claimed in claim 7, wherein the grain is a business definition of a measurement event that creates the fact, the dimension is a group of hierarchies that defines the context for the fact, and the fact is a measure indicating the dimension is true.

11. The analytics computing device as claimed in claim 7, wherein the processor coupled to the memory is further configured to be capable of executing at least one additional programmed instruction comprising and stored in the memory to display the orthogonal dimensional model to the user.

12. The analytics computing device as claimed in claim 7, wherein the processor coupled to the memory is further configured to be capable of executing at least one additional programmed instruction comprising and stored in the memory to provide an interactive user interface for displaying the information and prompting data entry by the user.

13. A non-transitory computer readable medium having stored thereon instructions for software analytics using business intelligence comprising executable code which when executed by a processor, causes the processor to perform steps comprising:
receiving an application parameter from a user for at least one application;
receiving data related to the application based on the received application parameters;
designing an orthogonal dimension model for the application based on the received application parameters; and
modeling the received data into the designed orthogonal dimensional model.

14. The non-transitory computer readable medium as claimed in claim 13, wherein the data related to the application comprises a version history, a bug history, email archives, source code, one or more deployment logs, one or more root cause reports, one or more impact analysis reports, or one or more code review reports of the application.

15. The non-transitory computer readable medium as claimed in claim 13, wherein the designing further comprises:
identifying a business process, wherein the identifying includes gathering business requirements, a grain from the identified business processes, a dimension from the identified grains, and a fact from the identified dimensions; and
instructing to initiate the modeling of the orthogonal dimensional model.

16. The non-transitory computer readable medium as claimed in claim 13, wherein the grain is a business definition of a measurement event that creates the fact, the dimension is a group of hierarchies that defines the context for the fact, and the fact is a measure indicating the dimension is true.

17. The non-transitory computer readable medium as claimed in claim 13, wherein the modeling further comprises displaying the orthogonal dimensional model to the user.

18. The non-transitory computer readable medium as claimed in claim 13, further having stored thereon at least one additional instruction that when executed by the processor cause the processor to perform at least one additional step comprising providing an interactive user interface for displaying the information and prompting data entry by the user.
